(19) United States
(12) Patent Application Publication
(10) Pub. No.: US 2015/0339596 A1
(43) Pub. Date: Nov. 26, 2015

(54) Apparatus and Methods of Recommending Multiple Options to a Group of Remote Users and Forming an Agreement

(71) Applicant: THOMSON LICENSING, Issy de Moulineaux (FR)

(72) Inventors: Efstratios IOANNIDIS, San Francisco, CA (US); Jinyun YAN, Sunnyvale, CA (US); Sandilya BHOMIDIPATI, Palo Alto, CA (US)

(21) Appl. No.: 14/410,206

(22) PCT Filed: Jun. 21, 2013
(86) PCT No.: PCT/US13/47018

§ 371 Date: Dec. 22, 2014

Related U.S. Application Data
(60) Provisional application No. 61/662,994, filed on Jun. 22, 2012.
(60) Provisional application No. 61/662,986, filed on Jun. 22, 2012.

(51) Int. Cl. G06Q 10/02; G06Q 30/06

(52) U.S. Cl. CPC G06Q 10/02; G06Q 30/0631

(57) ABSTRACT

Methods and apparatus for a system providing group recommendations, event scheduling, and forming consensus agreements among a group of disparately located users are provided by the present principles. Communication among the disparately located users may be achieved through social media tools, online polling, chatting, and texting. The methods and apparatus allow a user profile to be constructed based on ratings that a user provides to items in a database. The items may comprise such things as restaurants, movie theaters, or other entertainment and group activities. The items may comprise feature vectors including attributes of the individual items. With user profiles constructed, the methods and apparatus may allow prediction of a rating that an individual with a particular user profile may give to a similar item in a database. The system may be used to predict the best choice for a group activity by considering the ratings of all users within a group. Individual ratings may be weighted to give higher or lower priority to some users. The system may also recommend activities based on the users participating in the group, or allow the users to select other activities to be considered. In one exemplary embodiment, the system selects recommendations for the users, comprising elements such as movie title, theater location, seating, and prices. The system sends notifications to the users, collects preferences from the users, and determines a choice based on the collected preferences. The users are notified of the choice and given an opportunity to purchase tickets electronically. If so, they may receive electronic tickets, coupons, promotions, or offers.

### CROSS-REFERENCE TO RELATED APPLICATIONS

This application claims the benefit of U.S. Provisional Application Ser. No. 61/662994, filed Jun. 22, 2012, and U.S. Provisional Application Ser. No. 61/662986 , also filed Jun. 22, 2012, which are incorporated by reference herein in its entirety.

### TECHNICAL FIELD

The present principles relate to apparatus and methods for providing individual and group recommendations, event scheduling, movie event scheduling, and forming consensus agreements among people in disparate locations.

### BACKGROUND OF THE INVENTION

Recent technical advancements have allowed social media to become increasingly more popular. Friends can chat, text, send pictures, or post information about themselves through various forms of social media sites, even though they are in disparate locations.

Some applications and websites allow users to organize online polls, allowing their friends to select among a variety of options, such as which event the group would like to attend, or in which activity they should participate. The website “Doodle.com” is one such website.

Fandango provides a service for single users to find movie ticketing information and buy tickets online. Users can login through the account registered by Fandango or their Facebook account. Fandango maintains a profile of the user and stores his purchase records.

However, the Fandango system ignores the fact that most times, people watch a movie in the theater with their friends or family. Although a user can buy more than one ticket through Fandango, Fandango cannot distinguish which individual people are behind the multiple tickets, thus hurting the accuracy of user profiling algorithm.

When a group of users want to go to a cinema and watch a movie, they usually go through a long discussion by email or phone calls to make a decision. Doodle.com and other online survey services allow organizers to create a poll and collect members' opinions, but it does not offer solutions to the problem of helping them form a decision. There are too many details that need group decisions; one-time polling is not guaranteed to generate the final result that satisfies the group; users still have the burden to find the useful information offline or manually, and reach group agreement slowly by many rounds.

One problem with many of these sites is that the group of users receives no recommendations or options for their event or activity. Another problem is that the website has no information regarding the preferences of the users.

### SUMMARY OF THE INVENTION

These and other drawbacks and disadvantages of the prior art are addressed by the present principles, which are directed to methods and apparatus for generating a user profile of a user, selecting an item for recommendation to a user, forming recommendations for groups, event scheduling and forming consensus agreements, while learning user preferences through the recommendations, while the users are in disparate locations.

According to an aspect of the present principles, there is provided several methods and several apparatus for constructing a profile of a user and generating recommendations.

A first method for generating a user profile of a user is comprised of steps for receiving a plurality of ratings the user has previously assigned to items in a database. The method further comprises the steps of receiving a matrix comprising features of said items in a database, and finding a solution to a system of linear equations comprising said plurality of ratings and said matrix to generate a profile of a user.

According to another aspect of the present principles, there is provided an apparatus for generating a user profile of a user. The apparatus is comprised of a first receiver to receive a plurality of ratings the user has previously assigned to items in a database. The apparatus also comprises a second receiver to receive a matrix comprising features of the items in a database, and a processor that solves a system of linear equations comprising the plurality of ratings and the matrix to generate a profile of a user.

According to another aspect of the present principles, a second method is directed to selecting an item from a database for a user. The second method comprises a step for selecting a plurality of possible items from a database. The method further comprises predicting a rating that the user would assign to each of the plurality of possible items in the database based on a profile of the user and on features of each of the plurality of possible items. The method further comprises selecting an item from the selected plurality of possible items based on the predicted ratings.

According to another aspect of the present principles, a second apparatus is directed to selecting an item from a database for a user. The apparatus is comprised of a first selector to choose a plurality of possible items from a database. The apparatus further comprises a prediction circuit to generate a rating that the user would assign to each of the plurality of possible items in the database based on a profile of the user and on features of each of the plurality of possible items. The apparatus further comprises a second selector to choose an item from the selected plurality of possible items based on the predicted ratings.

According to another aspect of the present principles, there is provided a third method, which is directed to selecting an item from a database for a group of users. The method comprises a step for selecting a plurality of possible items from a database. The method further comprises a step of determining a rating for each of the plurality of possible items from the database for each user in the group of users. The method also comprises steps of assigning a weight to the rating of each user for the plurality of possible items, and of determining a score for each of the plurality of possible items based on the assigned weights for each user and on ratings of the plurality of possible items from each user in the group of users, and of selecting an item from the plurality of possible items based on said determined score.

According to another aspect of the present principles, a third apparatus is directed to selecting an item from a database for a group of users. The apparatus comprises a first selector to choose a plurality of possible items from a database, a first processor to calculate a rating for each of the plurality of possible items from the database for each user in the group of users, and circuitry to assign a weight to the rating of each user for the plurality of possible items. The apparatus further comprises a second processor to calculate a score for each of the plurality of possible items based on the assigned weights for each user and on ratings of the plurality of possible items from each user in the group of users, and a second selector to choose an item from the plurality of possible items based on the determined score.

According to other aspects of the present principles, there are provided a method and an apparatus for movie scheduling, directed to the problem of providing a one stop experience for a group of disparately located users wanting to schedule a time to watch a movie in a theater, as well as assisting a ticketing company to find more accurate targets and sell tickets more effectively.

A method for scheduling an event for a group of disparately located users is comprised of steps sending notification to a plurality of users, or invitees, regarding an event. The method further comprises steps for providing recommendations for the event to the plurality of users, collecting the preferences from the invitees, and forming a choice for the event from the invitees' preferences. The method further comprises steps for accepting payment for the event from the invitees and sending them electronic information for the event, such as a ticket.

According to another aspect of the present principles, there is provided an apparatus for scheduling an event for a group of disparately located users comprising a first transmission device for notifying a plurality of users regarding an event, a first processor for providing a plurality of recommendations regarding the event to the plurality of users based on information about the users, and collection circuitry that collects preferences regarding the recommendations from the plurality of users. The apparatus is further comprised of a second processor which selects one recommendation for the event from the plurality of recommendations based on the collected preferences and a second transmission device, used to send notifications to the plurality of users indicated the selected recommendation for the event. The apparatus further comprises an interface that provides users an opportunity to purchase tickets to the selected recommended event that has been determined and a third transmission device, used to send electronic information for the selected event to the users who purchased tickets.

These and other aspects, features and advantages of the present principles will become apparent from the following detailed description of exemplary embodiments, which are to be read in connection with the accompanying drawings.

### BRIEF DESCRIPTION OF THE DRAWINGS

FIG. 1 shows one embodiment of an interface for creating an event using the present principles.

FIG. 2 shows one embodiment of an interface for providing information for members of a group using the present principles.

FIG. 3 shows one embodiment of an interface for providing recommendations to a group using the present principles.

FIG. 4 shows one embodiment of an interface for querying a database using the present principles.

FIG. 5 shows one embodiment of an interface for users to provide ratings to recommended options using the present principles.

FIG. 6 shows one embodiment of an interface showing additional information to aid users in forming their decision using the present principles.

FIG. 7 shows one embodiment of a method for constructing a profile using the present principles.

FIG. 8 shows one embodiment of an apparatus for constructing a profile using the present principles.

FIG. 9 shows one embodiment of a method for selecting an item from a database using the present principles.

FIG. 10 shows one embodiment of an apparatus for selecting an item from a database using the present principles.

FIG. 11 shows one embodiment of a method for selecting an item from a database for a group of users using the present principles.

FIG. 12 shows one embodiment of an apparatus for selecting an item from a database for a group of users using the present principles.

FIG. 13 shows another embodiment of a method for selecting an item from a database for a group of users using the present principles.

FIG. 14 shows one embodiment of an overview of a user profiling component using the present principles.

FIG. 15 shows an embodiment of a service providing recommendations through online discussion using the present principles.

FIG. 16 shows an embodiment of the flow of offline polling using the present principles.

FIG. 17 shows an example of an embodiment of a digital seat map of a theater using with the present principles.

FIG. 18 shows an example of an embodiment of a user purchasing tool using with the present principles.

FIG. 19 shows an exemplary embodiment of a ticket purchasing interface using the present principles.

FIG. 20 shows the processing flow according to one embodiment of the present principles.

FIG. 21 shows a flow diagram of one embodiment using the present principles.

FIG. 22 shows one embodiment of a method using the present principles.

FIG. 23 shows one embodiment of an apparatus using the present principles.

### DETAILED DESCRIPTION OF THE INVENTION

The present principles are directed to a method and apparatus for electronically recommending options to a group of users and forming a consensus agreement when the users are located in disparate locations, and to methods and apparatus for a movie event scheduling system for a group of users, while helping a ticketing company find accurate targets and sell tickets more effectively.

At least one embodiment of this method and apparatus allows the system to simultaneously learn users' interests while aiding them in reaching a conclusion. Therefore, the present principles address the problem of providing recommendations to users in disparate locations for activities or events with a group of friends.

Compared to earlier work in this area, the present methods and apparatus recommend options to a group that are group dependent. In other words, the options are based on user profiles of those in the group. The methods and apparatus aid users in reaching an agreement on an event or activity. The methods and apparatus further use the data collected to profile the users. Compared to earlier work in the area of event scheduling, the present principles have several advantages over existing methods, for example (a) recommending movies that the group of users would like, (b) aiding users to reach an agreement on which movie, which theater, which time slot, and which seats should be chosen through an appropriate agreement phase, (c) providing a group payment service to calculate discounts and divide the bill for users, (d) promoting the movie through the users' social network, (e) using the data collected during the whole process to profile users and send relevant ads and sales information to users.

The website Doodle.com provides an interface enabling online users to organize polls, allowing their friends to select among a variety of options. However, the present described principles are different in a number of ways. First, the present principles provide recommendations of options to the users, as well as learning a user's preferences through those recommendations. Moreover, though recommendation and group recommendation systems exist, they rely on a priori knowledge of user preferences. In contrast, the present principles extend such systems by both aiding users to reach a consensus as well as by learning their preferences through this process.

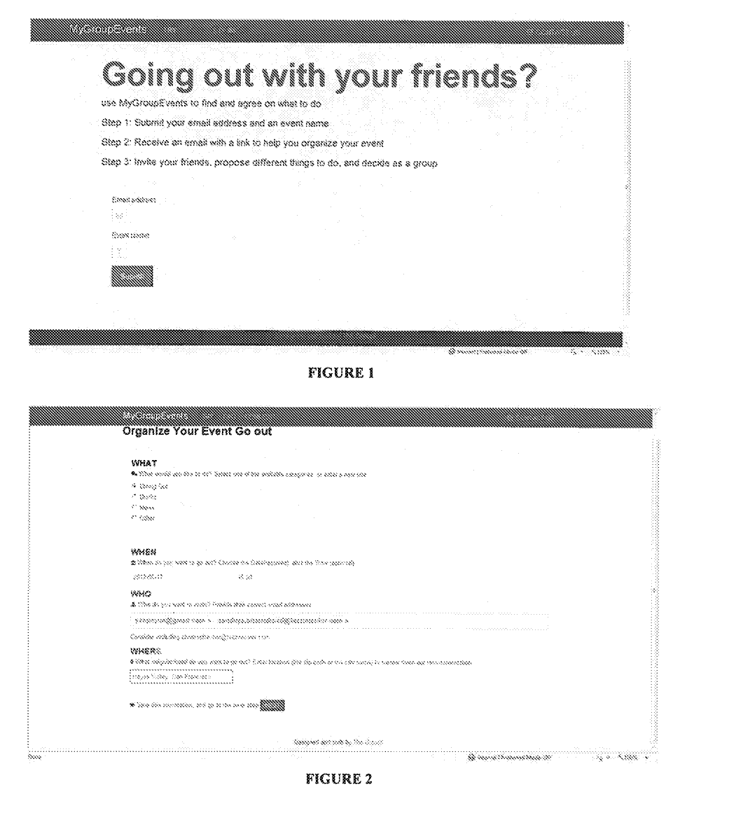

One embodiment of the present is an online application that may be accessed by a multitude of devices, such as smart phones, personal digital assistants (PDAs), laptops etc. In one such embodiment, a user, henceforth called the organizer, accessing the application is presented with a screen through which she can create an “event”, i.e., a joint activity with her friends. To create such an event, the organizer logs in by providing her credentials, for example. In another example, she does not login, but provides contact information that uniquely identifies her, such as an email address, Facebook identification, phone number, etc. An example of such an interface is shown in FIG. 1.

After providing their contact information and the name of an event, the organizer receives an invitation (for example, an email, a notification on their phone, etc.) to organize an event. Organizing an event comprises providing basic information about the event. This information may comprise the location of the event, the type of activity (for example, dining, attending a movie, going to a bar, etc.) as well as which of their other friends they will be inviting. To identify the friends, the organizer provides information uniquely identifying their friends, such as their email addresses, their Facebook identifications, their mobile phone numbers etc. An example of an interface for providing such information is shown in FIG. 2.

Based on the information the organizer provides, the application subsequently provides her with suggestions for particular activities. For example, the application may interface with an online database of restaurants, movies, or other activities. Then, based on the information specified by the organizer, including but not limited to type of event, location, as well as which friends have been invited, the application makes suggestions selected from this database that best fit the interests of the group. One suggested method using the present principles is discussed in more detail below. In brief, it uses the uniquely identifying contact information provided about participating users as well as preferences they have previously disclosed to generate recommendations. An example of an interface providing suggestions is shown in FIG. 3.

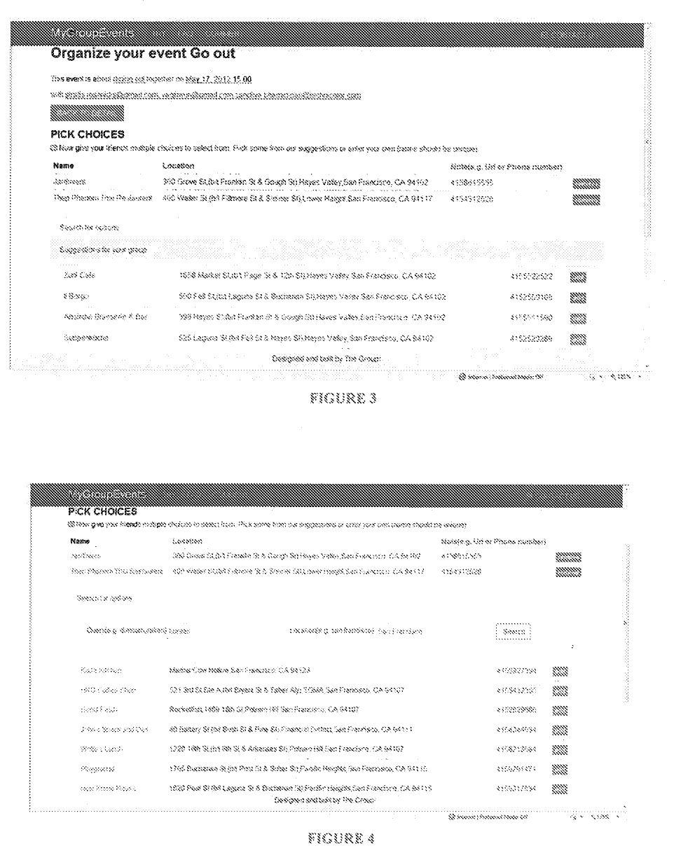

The organizer may pick among these suggestions (for example, restaurants, movies, etc.) as possible options for her event's activity. If no suggestions meet the organizer's needs, it may query the database directly using an appropriate interface. One such example interface is shown in FIG. 4. Upon selecting a sufficient number of possible options for the joint activity, the organizer confirms this selection and the application sends a notification to the organizer's friends, based on the uniquely identifying contact information the organizer has provided.

Subsequently, the process initiates an agreement phase, whereupon all participants express their preferences regarding the selected options. For example, the friends receiving a notification may access an interface allowing them to express their agreement or their preferences for the options selected by the organizer. Expressing their preferences may comprise rating the options, for example, on a scale from 1 to 5, or simply providing binary feedback (such as, like or dislike), as shown in FIG. 5.

At any point in the process, the organizer may conclude the agreement phase by selecting the options with the highest votes, for example, and use the application to send a notification to all, or a subset of, the invitees. The agreement phase may conclude in a variety of other ways, such as, but not limited to, selecting options with the highest votes among a selected subset of friends. This approach may be used when an organizer wishes to satisfy the wishes of the hardest to please friends, or those friends that the organizer feels may opt out if their choice is not the selection made.

In an exemplary embodiment of the application, the organizer, or any of the invited friends, may choose to add more options in the voting process. In this case, a similar interface to the one shown in FIG. 3 may be used. In such a case, the suggestions provided by the present methods may take into consideration the present selections of the participating users as well as their past selections, for example.

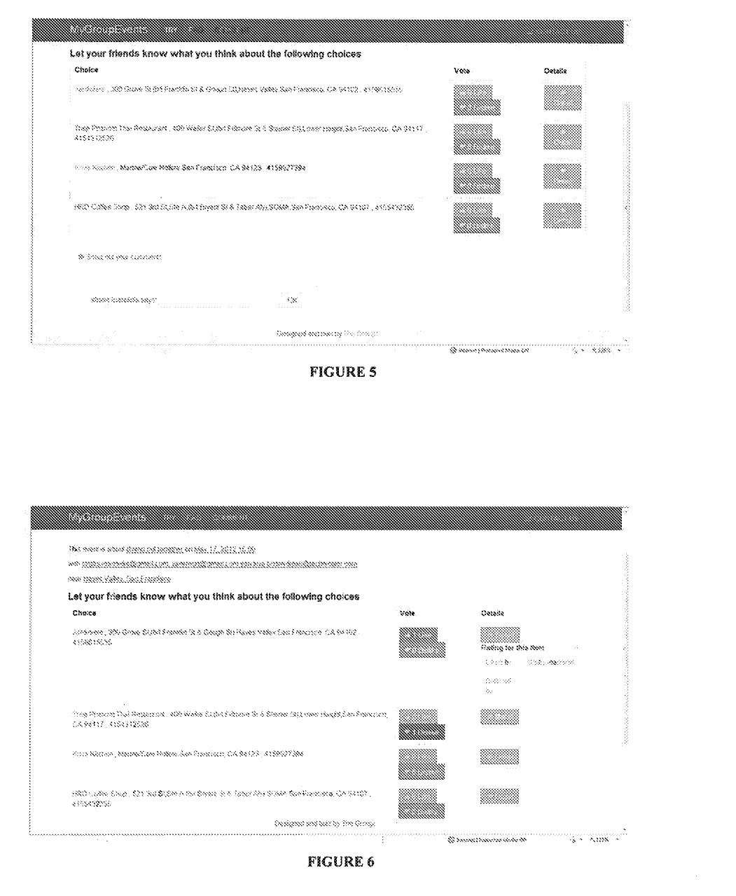

In addition, during the agreement phase, the application may choose to display different types of information to the users to aid them in their decision making process, as shown in FIG. 6. In particular, the application may choose to show information to the user about each option including, but not limited to, who among the group has presently voted for it and how they have voted regarding similar events in the past. The decision on what to show may be made with the aim of either maximizing the number of users that rate an item positively, or maximizing the number of users that agree with the organizer, for example.

The present methods may use the feedback that users provide to learn their preferences. In one embodiment, each item in the database is associated with a unique vector v describing the item's features. These features may either be explicitly described (for example, in the case of restaurants, cuisine type, number of stars, location, ambience, relative price, etc.) or implicitly derived (for example, computed through matrix factorization over past ratings). Using these profiles, for each user that has interacted with the application, either as an organizer or as an invitee, a user profile may be constructed by solving the following linear system in the least squares sense:

y=Ax

where x is the user profile, y is a vector of the ratings the user has provided (for example, 1-5) during previous agreement phases for different database items, and A is a matrix whose rows correspond to the feature vectors v of these items. Alternate methods, such as ridge regression, or logistic regression in the case of binary feedback, may be used.

To select which items to suggest to the user, the application may first pre-filter and fetch a subset of items from a database. This subset may be a large but manageable selection of items. These items may be filtered by type of activity being organized as well as the distance to the proposed location. Prefetching of such items, for example 10-11,000 of the items, may allow the application to then select targeted items that match the profiles of the users. In particular, the application may predict the rating r a user with profile x will give to an item with feature vector v as

r=<v,x>

Each item in the filtered list may then receive a score, which is a weighted average of the ratings the users in the group give to the items. The weights may be fixed or vary with the weight depending on the participant that gives the rating. For example, the organizer may receive a higher weight than other users, but the weights may also be determined by the organizer during runtime, as the organizer may specify which user or users it may deem more important.

Other criteria may also be used in the selection process. For example, the score of a pre-filtered item may receive an additional increment indicating whether this type of item has been visited by users recently. This may be used to make “fresh” suggestions, promoting items that are novel and interesting. For example, the increment to an item with profile v may be set as the weighted average among participants of the quantities:

v(B^{T}B)⁻¹v

where and B is a matrix whose rows correspond to the feature vectors v the participant has visited in the past, optionally multiplied by a discounting factor the older they are.

One embodiment of a method 700 for constructing a profile of a user using the present principles is shown in FIG. 7. The method is comprised of a step 710 for receiving assigned ratings that a user has previously assigned to items in a database. The method further comprises a step 720 for receiving a matrix comprising features of the items from the database. The method further comprises a step 730 for finding a least square solution to a system of linear equations, comprising the plurality of user ratings and the matrix comprising features, to generate a profile of the user.

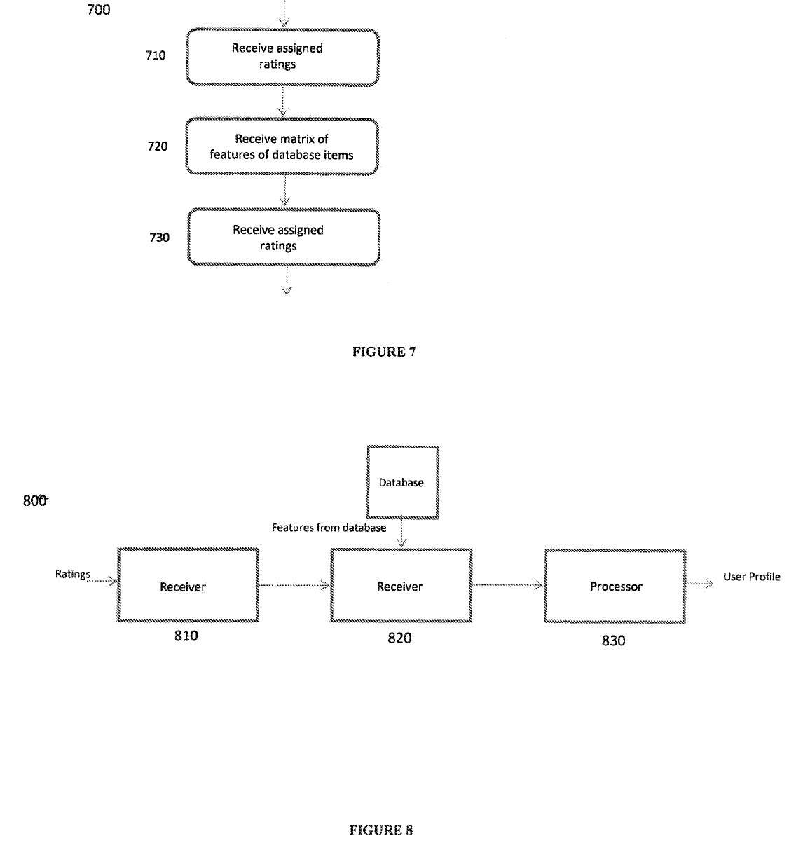

An embodiment of an apparatus 800 for constructing a profile of a user under the present principles is shown in FIG. 8. The apparatus is comprised of a receiver 810 for receiving assigned ratings that a user has previously assigned to items in a database. The output of receiver 810 is in signal communication with a first input of receiver 820 for receiving a matrix comprising features of the items from the database on a second input. The output of receiver 820 is in signal communication with an input of processor 830 for finding a least square solution to a linear system of equations, comprising the plurality of user ratings and the matrix comprising features, to generate a profile of the user.

An embodiment of a method 900 for selecting an item from a database for a user under the present principles is shown in FIG. 9. The method comprises a step 910 for selecting a plurality of possible items from a database. The method further comprises a step 920 for predicting a rating that a user would assign to each of the plurality of possible items in the database. The prediction is based on a profile of the user and on features of each of the plurality of possible items. The method further comprises a step 930 for selecting an item from the plurality of possible items selected in step 910, based on the predicted ratings.

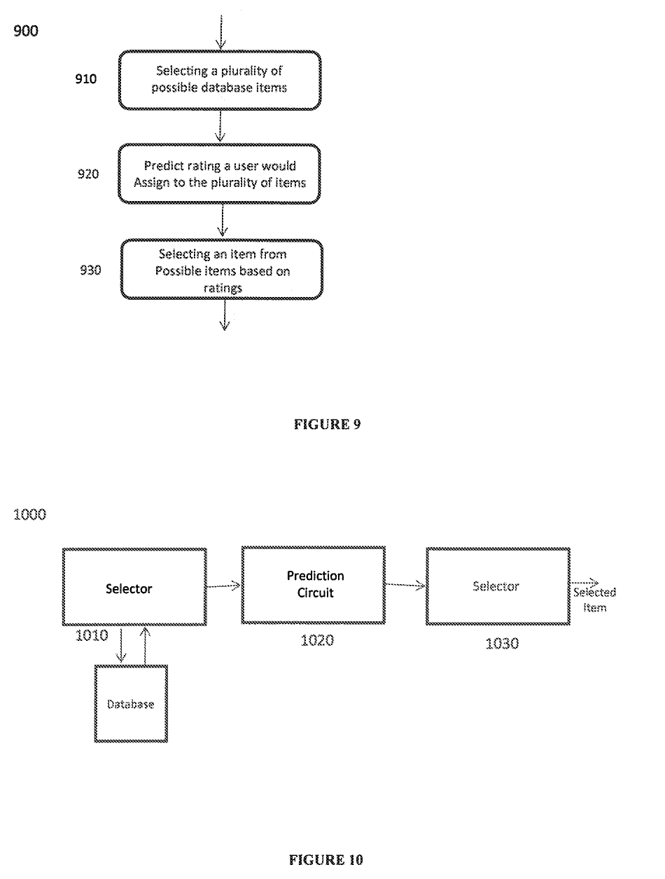

An embodiment of an apparatus for selecting an item from a database for a user under the present principles is shown in FIG. 10. The apparatus is comprised of a selector 1010, used to select a plurality of possible items from a database. One output of selector 1010 is the plurality of possible items from the database and is in signal communication with an input of a prediction circuit 1020, for predicting a rating that a user would assign to each of the plurality of possible items in the database. The prediction is based on a profile of the user and on features of each of the plurality of possible items. The output of prediction circuit 1020 is in signal communication with an input of selector 1030 for selecting an item from the plurality of possible items selected by selector 1010, based on the predicted ratings.

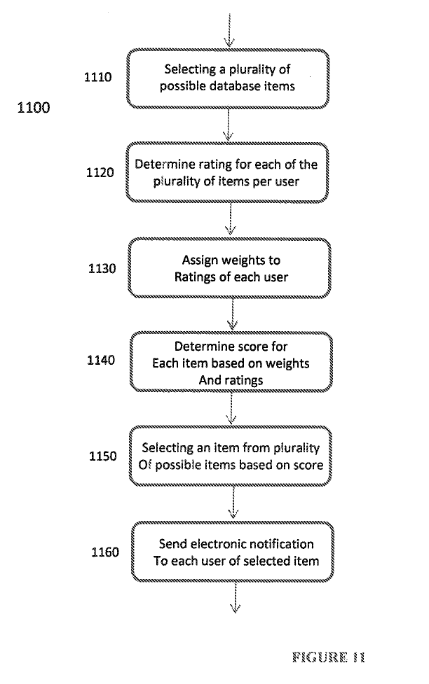

An embodiment of a method 1100 for selecting an item from a database for a group of disparately located users under the present principles is shown in FIG. 11. The method comprises a step 1110 for selecting a plurality of possible items from a database. The method then passes control to a step 1120 for determining a rating for each of the plurality of possible items from the database for each user in the group of users. Control is then passed to step 1130 for assigning a weight to the rating of each user for the plurality of possible items. Control is then passed to step 1140 for determining a score for each of the plurality of possible items based on the assigned weighs for each user and on ratings of the plurality of possible items from each user in the group of users. Control is then passed to step 1150 for selecting an item from the plurality of possible items based on the determined score from step 1140. Control is then passed to step 1160 to send electronic notification to each user in the group of users identifying the selected item.

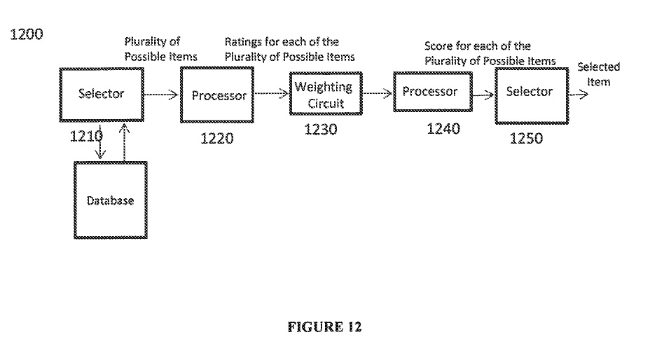

An embodiment of an apparatus 1200 for selecting an item from a database for a group of users under the present principles is shown in FIG. 12. The apparatus comprises a selector 1210 for selecting a plurality of possible items from a database. The output of selector 1210 is in signal communication with an input of processor 1220, which determines a rating for each of the plurality of possible items from the database for each user in the group of users. The output of processor 1220 is in signal communication with an input of circuit 1230 that assigns a weight to the rating of each user for the plurality of possible items. The output of circuit 1230 is in signal communication with processor 1240 that determines a score for each of the plurality of possible items based on the assigned weighs for each user and on ratings of the plurality of possible items from each user in the group of users. The output of processor 1240 is in signal communication with selector 1250 that selects an item from the plurality of possible items based on the determined score from processor 1240.

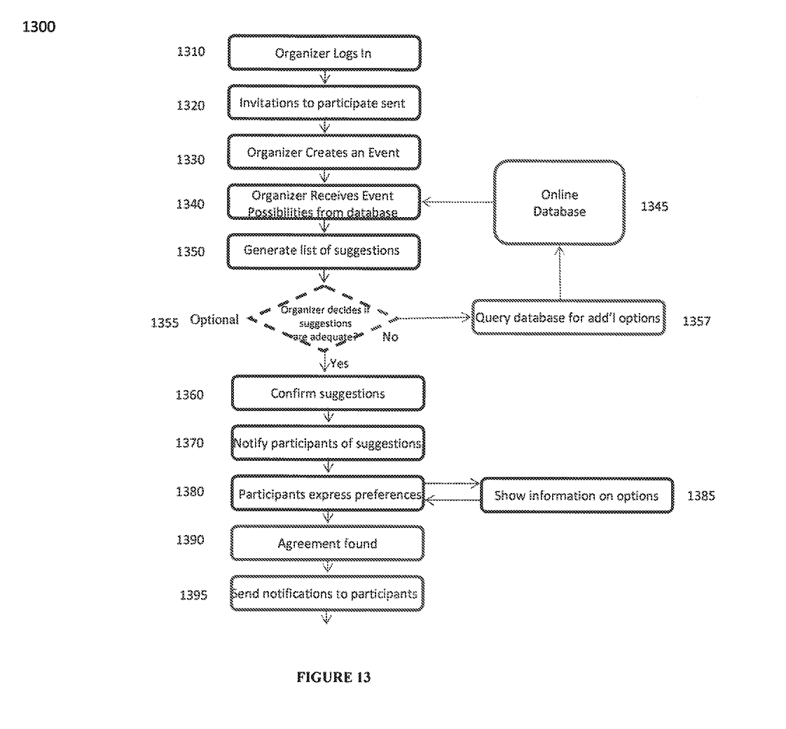

Another embodiment of the present principles is shown by the method 1300 of FIG. 13 for organizing an event among a group of disparately located participants. The method is comprised of a step of 1310 wherein an organizer logs in to an application using the present principles. Control is then passed to step 1320, in which the application sends out invitations to participate to those that are specified by the organizer. Control is then passed to step 1330 in which the organizer creates the event that will be planned by the organizer. Control is subsequently passed to step 1340 in which the organizer receives event possibilities from a database. The database may be an online database, accessible by the application, for example. Control is then passed to step 1350 comprising the application generating a list of suggestions for the event. Control may next be passed to step 1355, although this step is optional. Step 1355 comprises the organizer deciding if the suggested possibilities from the application are adequate. If not, control may be passed to step 1357 for querying the database for additional options. Otherwise, control is passed to step 1360 for confirming suggestions and on to step 1370 for notifying the participants of the group of the suggestions for the event. Control is then passed to step 1380 comprising the participants expressing preferences for the suggestions for the event. If the participants, or the organizer, request more information on the suggested options, step 1385 is performed and additional information is sent to the participants. Control is then passed to step 1390 comprising forming an agreement on the suggested event activity. Control is then passed to step 1395, comprising sending notifications to the participants regarding the agreed upon activity.

An exemplary embodiment of a movie scheduling system using the described principles will now be discussed.

A system using the present principles is not simply a tool to buy group tickets, nor to create a poll for the group. The principles provide an online service to help the group find out which movie to watch, which theater to attend, times to watch movies, where to sit in the theater, and how to pay as a group. By connecting each ticket to a person, it can more accurately profile a user's interests in movies. This framework integrates smoothly with ticketing websites, therefore once the group finalizes their decision about the content, they can choose seats and buy tickets together.

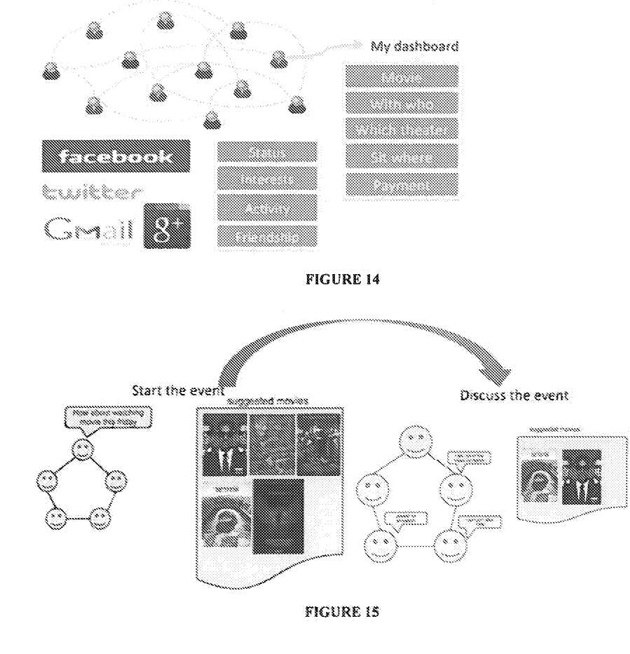

The principles comprise a framework of an online service, which is accessible by multiple devices, such as laptop, smart phones, tablets or other computing tool. The system connects to existing social networks, for example, Facebook, Google plus, Twitter or similar sites. The system also maintains a profile of users, including gender, occupation, activities (likes, comments), text status (tweets), for example. Such information may be used to assist in profiling the movie preference of the user. The system may refer to the work about gender and movies. It may also maintain a specific profile for movie events of the user. Users can see the information through a dashboard, for example. Such information may be useful for the system under the present principles to get better recommendation results. FIG. 14 shows one embodiment of an overview of the user profiling component in the present framework.

Users may initialize an event regarding watching movies in the theater. One embodiment of the present is an online application that may be accessed by a multitude of devices, such as smart phones, personal digital assistants (PDAs), laptops etc. The organizer first chooses friends, and may start the event scheduling in a variety of ways. One way, for example, is online discussion. Another way is offline polling. There may be a number of additional methods to start the event scheduling. FIG. 15 shows one embodiment of a service that provides recommendations through online discussion.

The system embeds the algorithm that provides recommendations based on the conversation among a group of users. The movies are partitioned and some partitions are filtered out by the keywords in the conversation. This may be an extension of a group of twenty question algorithms, for example.

As to the offline polling, the organizer may act as an administrator. The organizer may select a number of choices and then ask his friends' opinions. The system may suggest choices for the administrator and help him find good choices for the group. After the administrator decides among several choices, each member may receive an invitation to the event with a list of choices. In an exemplary embodiment of the application, the organizer, or any of the invited friends, may choose to add more options in the voting process. In such a case, the suggestions provided by the present methods may take into consideration the present selections of the participating users as well as their past selections, for example.

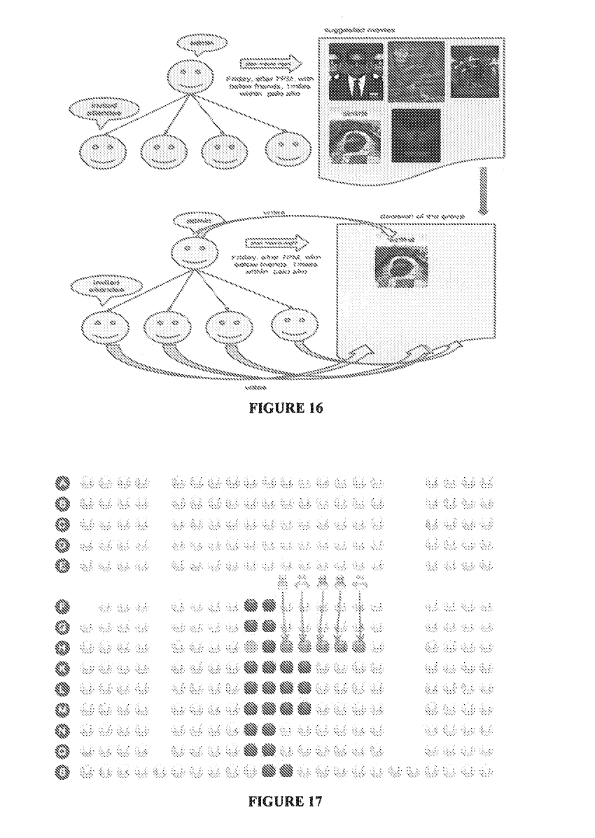

The group may make a final decision by collecting opinions from all, or a subset of, its members. FIG. 16 shows one embodiment of the flow of the offline polling. This system may assist the members to reach consensus by selectively showing useful information to each member and helping them determine a choice, for example. An exemplary recommendation algorithm that may be used with the present invention is disclosed later.

The content of the discussion among the group can be the selection of a movie, as shown, for example, in FIGS. 15 and 16, but may also be choice of theater to go and a seat to pick. As to seat reservation, the system may sketch a framework with cooperation from theaters. The system may maintain a digital seat map for each room in each theater. When one ticket is sold, the corresponding seat is also selected, for example. The system may be updated in real time whenever one seat is sold either online or from the ticketing box in the selected theater. A group of users often prefer to select seats next to each other. The group may, for example, view the seat map together and select a group of seats. For some popular movies, it is possible that many seats are taken. Then the group may need to sit separately or find another timeslot which has enough seats available in a group. Given such information, the group needs to decide whether to change a timeslot or sit separately. FIG. 17 shows an embodiment of an example screen of the digital seat map of a theater for a movie, where a first color/shading of seats represents the available seats, a second color/shading of seats represents those occupied by others. A third color/shading of seats represents those chosen by the group. For some unpopular seats, for example, those in the first row, the theater may decide whether they will provide some discount or coupons with those seats, in order to minimize empty seats and increase the revenue. The system may display such sale information once it is made available by the theater. The present system may also learn the seating behavior of a user, for example, thus recommending movies and timeslots that have their favorite seats.

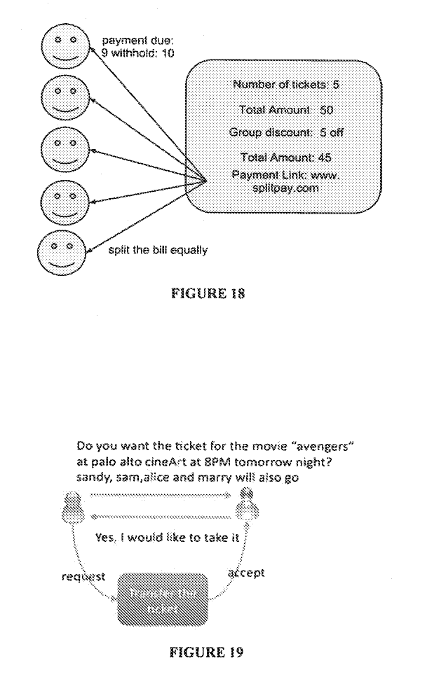

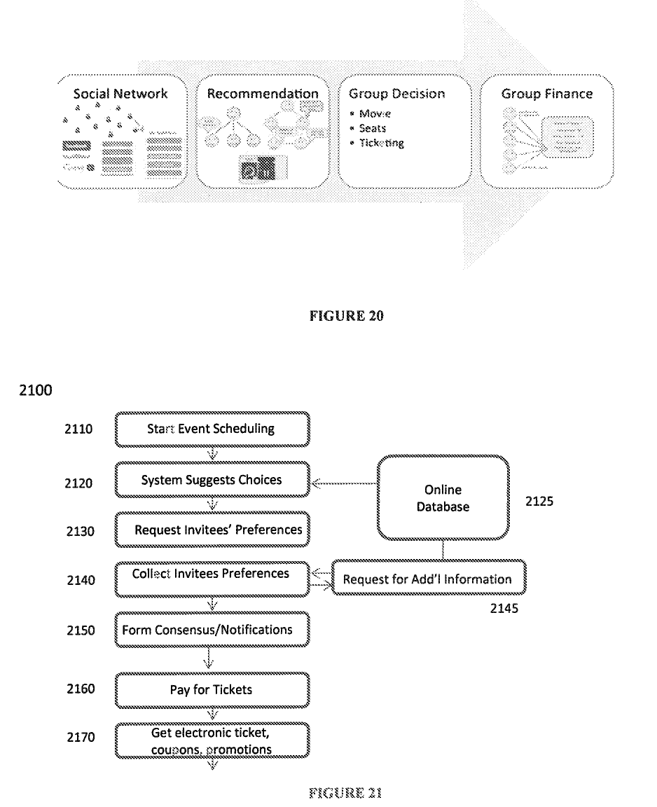

The last step is to pay for the theater tickets. FIG. 18 shows an example of the case when every member in the group wants to split the bill equally. Theaters may decide whether they offer a coupon based on the group size, for example. As an example, the figure shows that the discount is 5 dollars off for a group with size 5. In this embodiment, through a payment link generated by the ticketing company, the discount may be applied directly to each member's account, withholding 10 dollars. When all members pay and the group size reaches 5, for example, one dollar may be returned to every member. If the group size is smaller than 5, for example if one member cannot make it to a movie, the ticket price may remain at 10 dollars each. Theaters may also offer popcorn coupons, or other such promotions, for the group which may only be used once by the group, for example. In addition, every member may get an electronic ticket with barcode or QR (Quick Response) code. The electronic ticket may be scanned at the theater. Users don't need to wait for a long line to buy tickets or to print the paper ticket for the online reservation.

There are cases that a user cannot join the event for some unexpected reasons. The system under the present principles allows easy ticket transfers. A user may transfer the ticket to one of his friends if his friend would like to take the ticket. FIG. 19 shows an example of such a transfer. The receiver may get a new barcode to be scanned at the theater.

After an event, the system may be used to encourage users to review the movie, for example, on their social network, either through the offering of a coupon or by accumulating points which can be used in exchange for tickets, or small gifts. When the event is a group event, users tend to give higher ratings because they enjoy the company of their friends. This helps the promotion of a movie. Good reviews or comments will spread through a social network.

Theaters will, therefore, benefit from the proposed system. The theaters have better profiles of users, and may send relevant advertisements to them. When group patterns are determined, theaters may send ads like “I think your friends X, Y, Z would like movie A too! Would you want to plan a movie night with them?” Theaters may design some coupons or promotional methods to increase the loyalty of users who live nearby.

One embodiment of the present principles is shown by the flow diagram of FIG. 21. The system processing begins with the start of event scheduling in step 2110. Control is then passed to step 2120 in which the system suggests choices for movies, locations, etc. that a group of users may want to attend. The choices suggested by the system may be obtained from an online database, such as shown in step 2125. Control is passed from step 2120 to step 2130, in which the system requests the preferences of a group of invitees, which may have been specified by an organizer for the movie event. The preferences may be requested through online polling, discussion forums, chats, etc. Control is passed from step 2130 to step 2140 in which the invitees' preferences are collected by the system. The invitees may, optionally, request additional information about the movies, theater locations, prices, etc. in step 2145 which is obtained from the database. Control is passed from step 2140 to step 850 in which the system forms a consensus choice, which may comprise movie to be seen, location of theater, seating etc. Step 2150 may also send notifications to the group of invitees informing them of the consensus choice and the details that it comprises. Not shown in the flow diagram, but the process may comprise additional optional steps, for altering the consensus choice at the discretion of the organizer, or upon suggestions from the invitees.

After a consensus choice is made and notifications are sent, the group of invitees may be allowed to pay for their tickets in step 2160. Those invitees that change their mind, or are unable to attend the movie, do not have to pay for their ticket in step 2160. For those that do, control is passed from step 2160 to step 2170, in which the invitees receive an electronic ticket that can be printed. They may also receive coupons, promotions, discounts, or other such offers.

The system may also allow changes in the tickets after they have been purchased, such as cancellations, refunds, or exchanges, for example. Additionally, the system may allow invitees to rate the movies, theaters, or experiences for the benefit of future moviegoers.

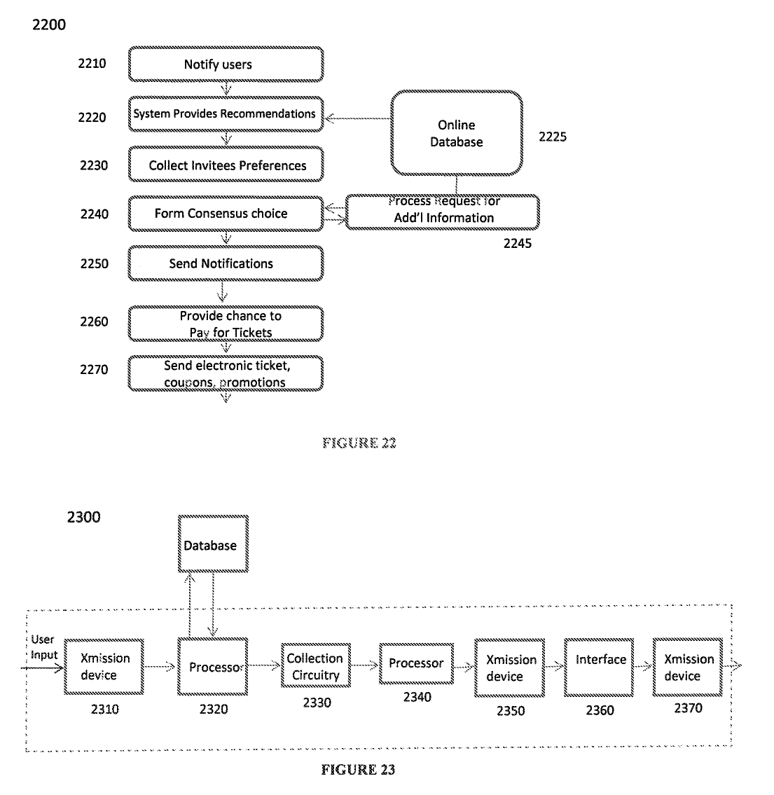

One embodiment of a method 2200 for scheduling an event for a group of disparately located users using the present principles is shown in FIG. 22. The method comprises a step 2210 of sending notification to a plurality of users, or invitees, regarding an event. Control is passed from step 2210 to step 2220 for providing recommendations for the event to the plurality of users. The recommendations may comprise various features of the event, such as choice of movie, genre, theater location, and price, for example. The method then passes control to step 2230, collecting the preferences from the invitees. The preferences may be regarding the plurality of recommendations sent to the invitees, or just general preferences that will aid the system in making an event recommendation. Control is passed from step 2230 to step 2240, which is forming a choice for the event from the invitees' preferences. As part of this process, the invitees might request additional information regarding the recommendations. The system may access a database and send additional information in a similar manner as sending the initial recommendations to the invitees.

After a choice is made by the system, preferably using the algorithms described herein, control is next passed to step 2250 in which notifications of the choice is sent to the invitees. Subsequently, control is passed to step 2260 and the invitees will have an opportunity to pay for tickets to the event. If payment is made, control is passed to step 2270 and the system sends electronic information to the paid invitees, comprising an electronic ticket, coupons, promotions, and offers, for example.

An embodiment of an apparatus 2300 for scheduling a theater event for a group of disparately located users under the present principles is shown in FIG. 23. The apparatus comprises a first transmission device 2310 for notifying a plurality of users regarding an event. The transmission device may, optionally, accept user input that specifies those users, or invitees, that should be notified. The output of first transmission device 2310 is in signal communication with processor 2320 for providing a plurality of recommendations regarding the event to the plurality of users based on information about the users. Processor 2320 may interface with an external database that comprises information regarding movies, theaters, and the users. The output of processor 2320 is in signal communication with circuitry 2330 that collects preferences regarding the recommendations from the plurality of users. The output of circuitry 2330 is in signal communication with a second processor 2340 which selects one recommendation for the event from the plurality of recommendations based on the collected preferences. The output of processor 2340 is in signal communication with a second transmission device 2350, used to send notifications to the plurality of users indicated the selected recommendation for the event. The output of transmission device 2350 is in signal communication with the input to interface 2360. Interface 2360 provides users an opportunity to purchase tickets to the selected recommended event that has been determined. The output of interface 2360 is in signal communication with the input to a third transmission device 2370, used to send electronic information for the selected event to the users who purchased tickets. In addition, the device 2370 may also send information to those not purchasing tickets to promote, for example, future events. The electronic information may comprise tickets, coupons, ads, promotions, etc.

One or more implementations having particular features and aspects of the presently preferred embodiments of the invention have been provided. However, features and aspects of described implementations can also be adapted for other implementations. For example, these implementations and features can be used in the context of other video devices or systems. The implementations and features need not be used in a standard.

Reference in the specification to “one embodiment” or “an embodiment” or “one implementation” or “an implementation” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

The implementations described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or computer software program). An apparatus can be implemented in, for example, appropriate hardware, software, and firmware. The methods can be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Implementations of the various processes and features described herein can be embodied in a variety of different equipment or applications. Examples of such equipment include a web server, a laptop, a personal computer, a cell phone, a PDA, and other communication devices. As should be clear, the equipment can be mobile and even installed in a mobile vehicle.

Additionally, the methods can be implemented by instructions being performed by a processor, and such instructions (and/or data values produced by an implementation) can be stored on a processor-readable medium such as, for example, an integrated circuit, a software carrier or other storage device such as, for example, a hard disk, a compact disc, a random access memory (“RAM”), or a read-only memory (“ROM”). The instructions can form an application program tangibly embodied on a processor-readable medium. Instructions can be, for example, in hardware, firmware, software, or a combination. Instructions can be found in, for example, an operating system, a separate application, or a combination of the two. A processor can be characterized, therefore, as, for example, both a device configured to carry out a process and a device that includes a processor-readable medium (such as a storage device) having instructions for carrying out a process. Further, a processor-readable medium can store, in addition to or in lieu of instructions, data values produced by an implementation.

As will be evident to one of skill in the art, implementations can use all or part of the approaches described herein. The implementations can include, for example, instructions for performing a method, or data produced by one of the described embodiments.

A number of implementations have been described. Nevertheless, it will be understood that various modifications can be made. For example, elements of different implementations can be combined, supplemented, modified, or removed to produce other implementations. Additionally, one of ordinary skill will understand that other structures and processes can be substituted for those disclosed and the resulting implementations will perform at least substantially the same function(s), in at least substantially the same way(s), to achieve at least substantially the same result(s) as the implementations disclosed. Accordingly, these and other implementations are contemplated by this disclosure and are within the scope of these principles.

1. A method for constructing a profile of a user, comprising:
receiving a plurality of ratings the user has assigned to items in a database;
receiving a matrix comprising features of said items in a database;
finding a solution to a system of linear equations comprising said plurality of ratings and said matrix to generate a profile of a user.

2. The method of claim 1, wherein said features are derived from ratings.

3. The method of claim 1, wherein said solution to a system of linear equations is found using least squares.

4. The method of claim 1, wherein said solution to a system of linear equations is found using ridge regression.

5. The method of claim 1, wherein said solution to a system of linear equations is found using logistic regression.

6. An apparatus for constructing a profile of a user, comprising:
a first receiver to receive a plurality of ratings the user has assigned to items in a database;
a second receiver to receive a matrix comprising features of said items in a database;
a processor that solves a system of linear equations comprising said plurality of ratings and said matrix to generate a profile of a user.

7. The apparatus of claim 6, wherein said features are derived from ratings.

8. The apparatus of claim 6, wherein said solution to a system of linear equations is found using least squares.

9. The apparatus of claim 6, wherein said solution to a system of linear equations is found using ridge regression.

10. The apparatus of claim 6, wherein said solution to a system of linear equations is found using logistic regression.

11. A method for selecting an item from a database for a user, comprising:
selecting a plurality of possible items from a database;
predicting a rating that said user would assign to each of said plurality of possible items in the database based on a profile of the user and on features of each of said plurality of possible items;
selecting an item from the selected plurality of possible items based on the predicted ratings.

12. The method of claim 11, wherein selecting a plurality of possible items from a database comprises filtering items in the database.

13. The method of claim 12, wherein said filtering is performed by type of activity.

14. The method of claim 12, wherein said filtering is performed by location.

15. The method of claim 12, wherein said filtering is performed by distance.

16. An apparatus for selecting an item from a database for a user, comprising:
a first selector to choose a plurality of possible items from a database;
a prediction circuit to generate a rating that said user would assign to each of said plurality of possible items in the database based on a profile of the user and on features of each of said plurality of possible items;
a second selector to choose an item from the selected plurality of possible items based on the predicted ratings.

17. The apparatus of claim 16, wherein selecting a plurality of possible items from a database comprises filtering items in the database.

18. The apparatus of claim 17, wherein said filtering is performed by type of activity.

19. The apparatus of claim 17, wherein said filtering is performed by location.

20. The apparatus of claim 17, wherein said filtering is performed by distance.

21. A method for selecting an item from a database for a group of disparately located users, comprising:
selecting a plurality of possible items from a database;
determining a rating for each of the plurality of possible items from the database for each user in the group of users;
assigning a weight to the rating of each user for the plurality of possible items;
determining a score for each of the plurality of possible items based on the assigned weights for each user and on ratings of the plurality of possible items from each user in the group of users;
selecting an item from the plurality of possible items based on said determined score
sending electronic notification to each user in the group of users identifying said selected item.

22. The method of claim 21, wherein selecting a plurality of possible items from a database comprises filtering items in the database.

23. The method of claim 21, wherein at least one item from the database is assigned a weighting factor prior to determining its score.

24. The method of claim 23, wherein the weighting factor is used to discount items from the database based on age of the item prior to determining its score.

25. An apparatus for selecting an item from a database for a group of disparately located users, comprising:
a first selector to choose a plurality of possible items from a database;
a first processor to calculate a rating for each of the plurality of possible items from the database for each user in the group of users;
circuitry to assign a weight to the rating of each user for the plurality of possible items;
a second processor to calculate a score for each of the plurality of possible items based on the assigned weights for each user and on ratings of the plurality of possible items from each user in the group of users;
a second selector to choose an item from the plurality of possible items based on said determined score
device to send electronic notification to each user in the group of users identifying said selected item.

26. The apparatus of claim 25, wherein selecting a plurality of possible items from a database comprises filtering items in the database.

27. The apparatus of claim 25, wherein at least one item from the database is assigned a weighting factor prior to determining its score.

28. The apparatus of claim 27, wherein the weighting factor is used to discount items from the database based on age of the item prior to determining its score.

29. A method for organizing an event among a group of disparately located users, comprising:
sending notification to a plurality of users regarding an event;
providing a plurality of recommendations regarding said event to said plurality of users based on information about said users;
collecting preferences regarding said recommendations from a plurality of the users;
selecting one recommendation for the event from the plurality of recommendations based on the collected preferences;
sending notifications to the plurality of users indicating the selected recommendation for the event;
providing to the plurality of users an opportunity to purchase tickets to said selected recommendation for the event;
sending electronic information for the selected recommendation for the event to said users purchasing tickets.

30. The method of claim 29, wherein collecting preferences comprises at least one of online polling, chatting, and texting.

31. The method of claim 29, wherein recommendations regarding said event comprise at least one of movie title, theater location, and seat location.

32. The method of claim 29, further comprising:
revising said electronic information based on at least one of the users altering a decision on whether to purchase a ticket.

33. The method of claim 29, further comprising:
providing to users an ability to rate the selected recommendation for the event.

34. The method of claim 29, wherein said providing step comprises interfacing with a movie purchasing website.

35. An apparatus for organizing an event among a group of disparately located users; comprising:
a first transmission device to notify a plurality of users regarding an event;
a processor that provides a plurality of recommendations regarding said event to said plurality of users based on information about said users;
circuitry to collect preferences regarding said recommendations from a plurality of the users;
a second processor to select one recommendation for the event from the plurality of recommendations based on the collected preferences;
a second transmission device to send notifications to the plurality of users indicating the selected recommendation for the event;
an interface that provides to the plurality of users an opportunity to purchase tickets to said selected recommendation for the event;
a third transmission device to send electronic information for the selected recommendation for the event to said users purchasing tickets.

36. The apparatus of claim 35, wherein collecting preferences comprises at least one of online polling, chatting, and texting.

37. The apparatus of claim 35, wherein recommendations regarding said event comprise at least one of movie title, theater location, and seat location.

38. The apparatus of claim 35, further comprising:
said third transmission device sends revised electronic information based on at least one of the users altering a decision on whether to purchase a ticket.

39. The apparatus of claim 35, further comprising:
an interface to provide to users an ability to rate the selected recommendation for the event.

40. The apparatus of claim 35, wherein said interface comprises an interface with a movie purchasing website.
